(19) United States
(12) Patent Application Publication
(10) Pub. No.: US 2017/0177390 A1
(43) Pub. Date: Jun. 22, 2017

(54) EXTENSIBLE FRAMEWORK WHICH ENABLES THE MANAGEMENT OF DISPARATELY LOCATED HETEROGENEOUS SYSTEMS REQUIRING COMMAND AND CONTROL, SITUATIONAL AWARENESS, OPERATIONS MANAGEMENT AND OTHER SPECIFIC CAPABILITIES

(71) Applicant: DREAMHAMMER PRODUCTS LLC, San Diego, CA (US)

(72) Inventors: Christopher DIEBNER, San Diego, CA (US); Carlos HERRERA, Monterey Park, CA (US)

(73) Assignee: DREAMHAMMER PRODUCTS LLC, San Diego, CA (US)

(21) Appl. No.: 15/222,488

(22) Filed: Jul. 28, 2016

Related U.S. Application Data
(63) Continuation of application No. 13/593,435, filed on Aug. 23, 2012, now abandoned.
(60) Provisional application No. 61/528,302, filed on Aug. 29, 2011.

(51) Int. Cl. G06F 9/445; G06F 9/54; G06F 9/44

(52) U.S. Cl. CPC G06F 9/44526; G06F 8/31; G06F 9/4443; G06F 9/44505; G06F 9/541; G06F 9/445

(57) ABSTRACT

The solution described herein, through it's unique design, provides capability such as command and control, situational awareness, operations management, and other tactical capabilities as building blocks to be added or extended for the buildout of specific strategic or tactical solutions. Traditional approaches for the implementation of strategic or tactical systems have historically been stove-piped and build on closed architectures. The solution is architected using open-standards and open-interfaces in order to simplify the integration into both new and legacy system.

### CROSS-REFERENCE TO RELATED APPLICATIONS

This application is a continuation application of U.S. application Ser. No. 13/593,435, filed Aug. 23, 2012, which claims the benefit of U.S. Provisional Application No. 61/528,302, filed Aug. 29, 2011, the contents of which are incorporated herein by reference in their entirety.

### BACKGROUND

Field of the Invention

The present invention relates to a method and apparatus for the management of heterogeneous disparately located systems. In particular, the current invention is directed toward a method and apparatus which enables a framework for the command & control, situational awareness, operational management and other capabilities of the aforementioned systems.

Background of the Invention

Currently deployed control segment management systems have delivered complex solutions to meet the warfighter requirements. The capabilities provided have been cutting edge, but have been implemented in such a way that stifles the expansion of such systems. The root of this problem is multifaceted, but can be summarized by the following architectural and operational flaws:
Undefined requirements for openness and externality lead to tightly coupled data layers between ground control segment and remote asset segments; effectively producing a long line of proprietary closed stovepipe systems.
External interfaces extremely difficult to maintain due to the fluidity of interface definitions (ICD) and specifications between the ground control segment and the systems it is controlling.
Often, these legacy systems do not allow for external vendors to bid or support existing legacy systems, leaving the customer with little to no choice but to continue to contract the incumbent.
Software targeted to run on specific hardware limits the capabilities and extensibility of the over all system. Adding or modifying capability is impossible to accomplish on existing systems, causing the customer to deploy new capabilities on disparate systems.
Integration with legacy interfaces is very expensive due to the inflexibility of the technologies used to develop them, as well as the tightly held grip invoked by the developing contractors with ownership to different segments of the system.
Clunky and disparate user interfaces lead to poor and inefficient mission execution.
Poorly thought out training infrastructure and cluttered operational views lead to long and expensive training cycles.

This method of providing multiple dedicated hardware systems and software applications has proven to have expensive long-run costs to develop, deploy, and support. In an effort to mitigate these trends, a roadmap outlines the proposed design for an open and extensible architecture built on the most current open standards.

### SUMMARY

An aspect of the present invention may reside m a method for providing a presentation layer with a customizable user interface. In the method, a first presentation service is registered with a dynamic service registry using a first plugin application programming interface (API). A first visualization of first data from a first data model is presented to a user using the first presentation service registered with the dynamic service registry.

In more detailed aspects of the invention, a second presentation service may be registered with the dynamic service registry using a second plugin application programming interface (API). A second visualization of second data from a second data model may be presented to the user using the second presentation service registered with the dynamic service registry. The a second infrastructure service may be removed from the dynamic service registry by removing the second plugin application programming interface (API).

In other more detailed aspects of the invention, a first infrastructure service may be registed with the dynamic service registry using a third plugin application programming interface (API). The first data model may be populated with data from the first infrastructure service. Further, a second infrastructure service may be registered with the dynamic service registry using a fourth plugin application programming interface (API). A second data model may be populated with data from the second infrastructure service. The first data model may include second data, and the user may selectively hide the second data from the presentation of the first visualization.

Another aspect of the invention may reside in an apparatus for providing a presentation layer with a customizable user interface, comprising: a first registered presentation service that presents a first visualization of first data from a first data model to a user; and a dynamic service registry that registers the first registered presentation service using a first plugin application programming interface (API).

Another aspect of the invention may reside in an apparatus for providing a presentation layer with a customizable user interface, comprising: means for presenting a first visualization of first data from a first data model to a user; and means for registering the first registered presentation service using a first plugin application programming interface (API).

Another aspect of the invention may reside in a computer program product, comprising: non-transitory computer-readable storage medium, comprising: code for causing a computer to register a first presentation service with a dynamic service registry using a first plugin application programming interface (API); and code for causing a computer to cause a present a first visualization of first data from a first data model to a user using the first presentation service registered with the dynamic service registry.

### BRIEF DESCRIPTION OF THE DRAWINGS

FIG. 1 shows an outline of core framework itself consisting of multiple, interconnected open interface frameworks supporting multiple disciplines.

FIG. 2 shows the infrastructure framework which consists of the applications, messaging and data handling modules.

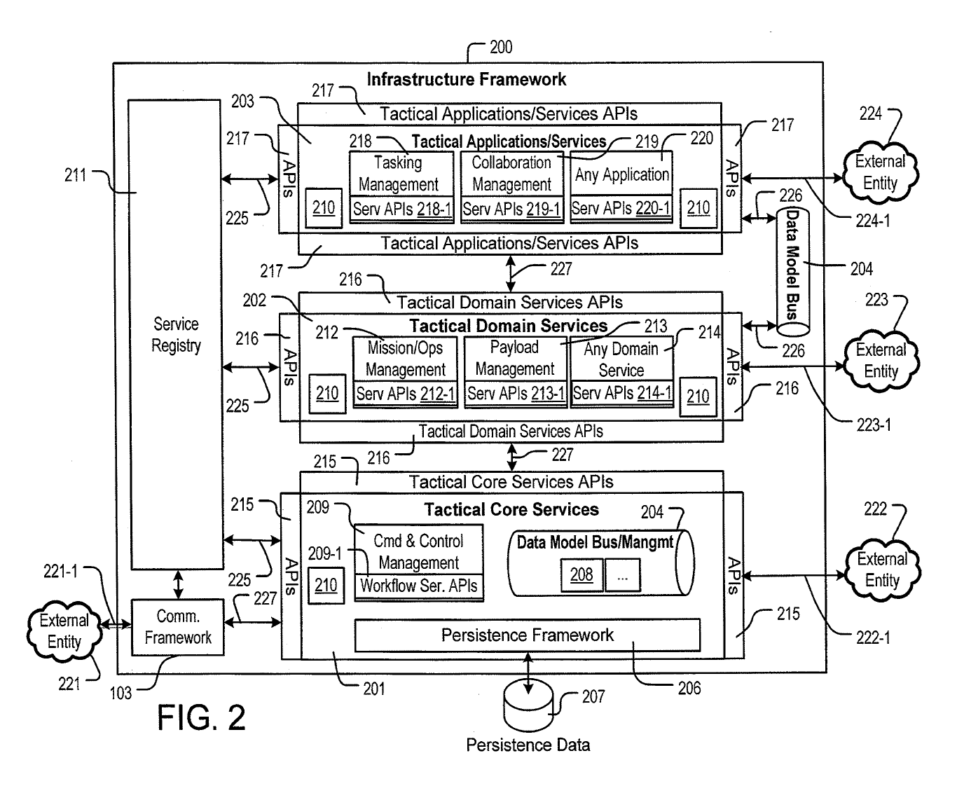

FIG. 3 shows the presentation framework.

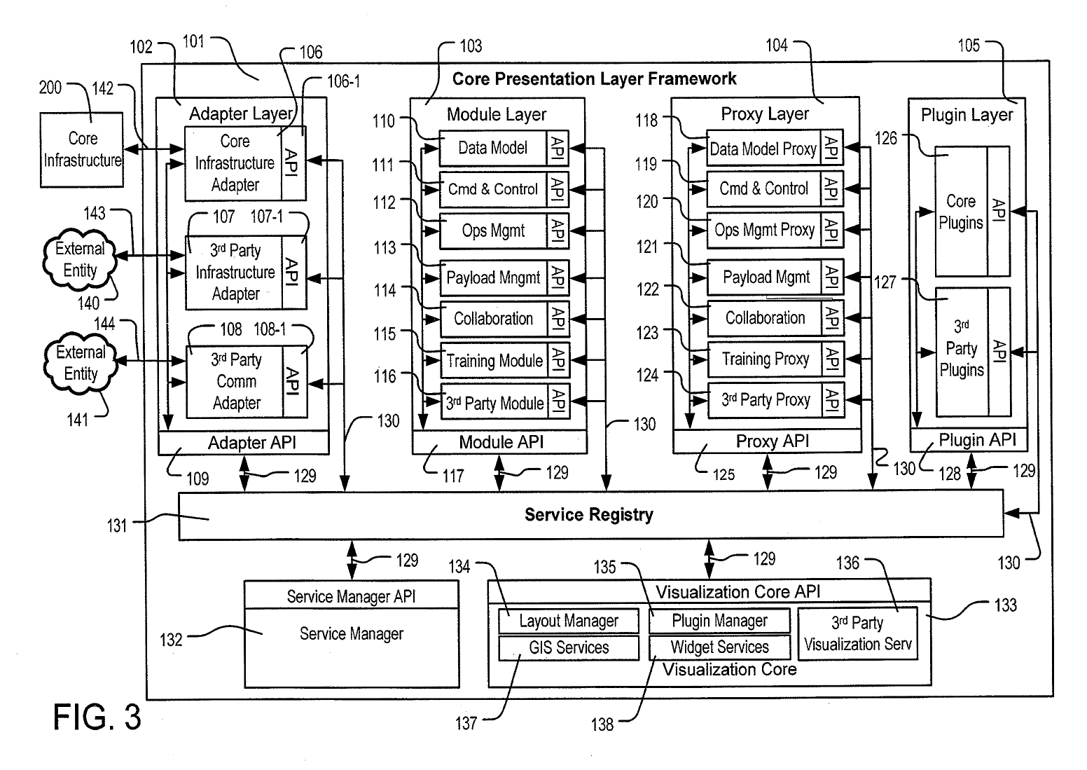

FIG. 4 shows the plugin framework.

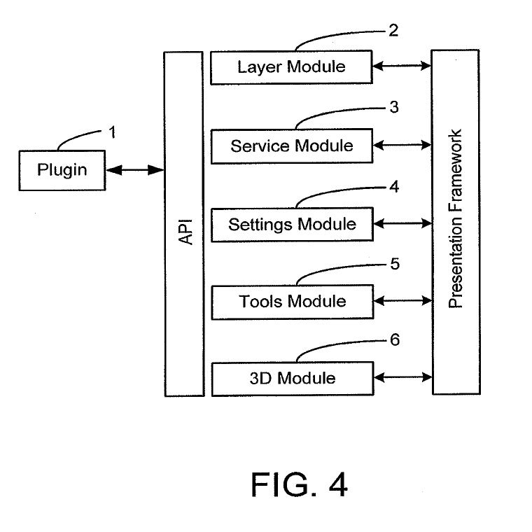

FIG. 5 shows the communications framework which consists of the services and packages that are designed to abstract hardware communications away from applications and expose their interfaces via standard SOA methods.

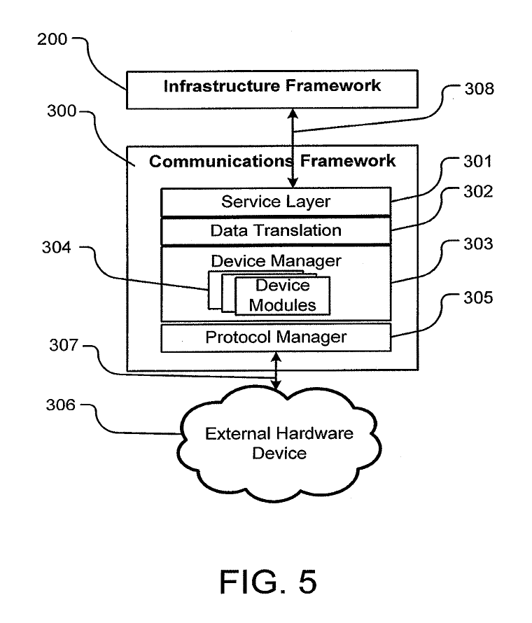

FIG. 6 shows the training framework which consists of the packages and modules that are designed to enable temporal control, feedback and scripting of system-wide events for training purposes.

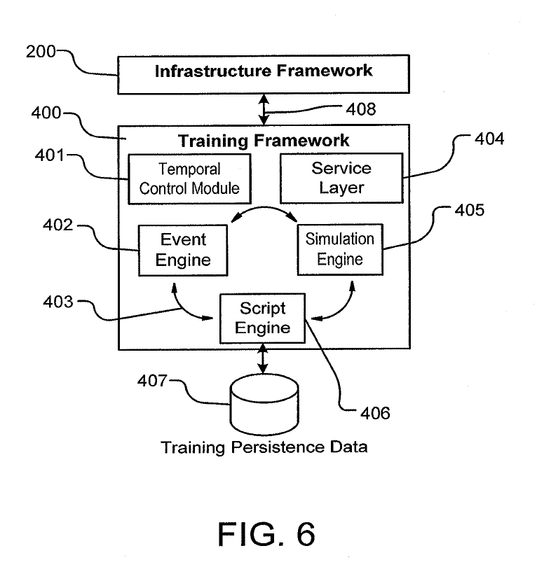

### DETAILED DESCRIPTION

In order to effectively address the aforementioned deficiencies inherent to currently deployed ground segment architectures, a comprehensive solution herein leverages open standards in order to create an open and extensible architecture. This architecture consolidates command & control (C2), situational awareness (SA), and operations management (OM) into one simple solution. The solution is implemented as a blend of the service-oriented architecture (SOA) and plugin architecture paradigms in order to allow for maximum extensibility as well as addition or removal of components. Leveraging off of this plugin and open-interface based architecture, targeted, specific applications can be built with little development effort. The user interfaces for this system should leverages off the 4-dimensional geospatial and temporal domains in order to provide the operators with true battle field and airspace awareness.

The solution for this common ground system architecture (CGSA) should be built on the notion of having the ability to perform command & control (C2), situational awareness (SA), and operations management (OM) for a generically defined remote asset or set of assets.

In order to effectively achieve the goal of having a common ground segment architecture, the solution needs to be architected in such a way as to effectively separate the core functionalities relating to the application framework away from the generic operational features (C2, SA, OM) relating to the interaction of the remote assets. Once implemented, these two loosely coupled layers will serve as the foundation for the integration of specific UAS systems, their sub-systems, and their related concepts of operation (CONOPS).

Moreover, the aforementioned core operational features (C2, SA, OM), should have the ability to be extended, augmented or complimented with other business applications in order to meet specific requirements for customer-specific solutions. For this reason, this core architecture should be implemented with open interfaces and API(s) allow the user community to develop custom-tailored solutions that conform to the core infrastructure. Having direct access to the core data modeling, utilities and infrastructure, the applications are limitless and highly extensible.

Core Framework

Currently deployed systems are very rigid, not allowing for effective extensibility and configurability. The modification of interfaces to these systems is expensive, especially if there are multiple systems involved in that interface. Adding functionality and/or systems requires modification to legacy systems and interfaces, which causes a ripple effect of impact to all systems involved. Oftentimes corners are cut or features are left out due to the integration cost of a small change.

Taking on the task of designing a core framework that is flexible, extensible and configurable requires a paradigm shift that involves the blending of two currently accepted architectural frameworks. First we take what is arguably the most flexible framework available today, the Service Oriented Architecture (SOA). SOA allows for the design of components and services to be fluid and ever changing, with little to no impact on external users of the system. In a nutshell, it provides optimum flexibility. Next we take the Plug-In framework that excels at extensibility and configurability by allowing the allocation interchangeable and expandable software units. Blending the flexibility of a SOA system with extensibility and configure-ability of a plugin system we reach our optimal solution with maximum flexibility, extensibility, and configurability.

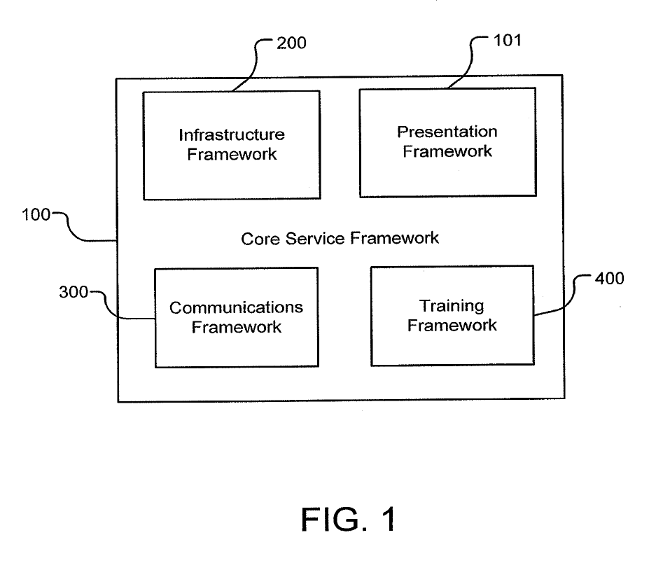

FIG. 1 shows the an outline of core 100 framework itself consisting of multiple, interconnected open interface frameworks supporting multiple disciplines. As depicted, the core framework serves as a housing for multiple targeted frameworks each with their own key role in the overall architecture. The frameworks housed within the core framework include: the Infrastructure Framework, the Presentation Framework, the Plugin Framework, the Communications Framework, and the Training Framework.

Component Breakdown:

101—Presentation framework designed to be completely decoupled from any infrastructure and communication through open interfaces.

400—Training framework designed to be able to record, playback, script and interact with in during training scenarios.

300—Communications framework designed to abstract hardware device I/O from the core framework, exposing their interfaces via open standards (web services, etc).

200—The heart of the inter-communications and applications running withing the system.

Infrastructure Framework

The infrastructure framework should sit on top of a widely used and supported open source stack that's fully Java EE 5.0+ compliant. It should allow features to be swapped in and out without impacting the workflow of the system. Leveraging off of open source standards as well as best practices, the infrastructure should be built specifically to be an ever growing and changing set of capabilities without impacting the clients.

The application server concept allows for a highly scalable and manageable infrastructure core. The application server serves as a host for business processes in a managed environment that is highly scalable and portable. Components can be easily deployed or un-deployed, without impacting the deployment of a system as a whole and all business processes conform to the open standards set by the Java development standards. The application server monitors and controls data access, load balancing, failover, clustering, etc. Legacy systems often have to build these capabilities into each and every application, making maintenance extremely expensive and severely impacting the systems scalability.

The application can deployed on a single monolithic workstation or can be clustered and deployed on multiple dissimilar platforms to fit the customer requirements. The open source application server enables this capability out of the box, only requiring minor configuration settings for a change in development environment.

The application server can be complimented with the use of a data translation bus such as an ESB (Enterprise Service Bus), JCA (Java Connection Architecture) or advanced data modeling frameworks such as DDS (Data Distribution Service). The use of an data bus is critical to integrating a system with multiple, dissimilar data feeds. The data bus is designed to be the translation layer between the infrastructure and external interfaces. The advantages of using such a bus is that they contain built-in service units that enable the developer in most cases to not have to write a single line of code to integrate to a new or legacy interface. Using configuration files, connecting to external systems is no longer an expensive, time-consuming effort.

Data model and data distribution is the heart of the messaging passing through the infrastructure. The architecture supports a wide variety of data distribution techniques, all using the same publish/subscribe paradigm for flexible and configurable data flow. Two commonly used data distribution mechanisms are JMS and DDS, both of which are supported with the infrastructure. JMS is an open standard that allows for the infrastructure to easily integrate into any system who also conforms to this very widely used standard. DDS is a more robust, real-time data distribution mechanism which focuses on a data centric model rather than an event based model like JMS.

At the core of the infrastructure are the core data models. In order to keep from stove-piping the SOA system, everything must be open and extensible, including, and most importantly, are the data models. Data models are ultimately the contracts that clients will conform to. The infrastructure framework allows core data models to be defined and then extended as the customer sees fit. The core data models allow external interfaces with dissimilar interfaces yet similar types of data to be represented as a single global model. The advantages of these core extensible data models are very valuable. If an external interface changes, the rest of the system does not have to change to interface with this system. The data models change, but the interfaces stay the same. This is a huge cost savings as software systems are constantly evolving and tweaking interfaces. To keep the application compliant with these changes, configuration files need to be changed, but no software.

Component Breakdown:

200—Infrastructure framework which can consist of any number of application severs, messaging buses, translation services and database services.

201—Tactical core services meant to contain all of the underlying data translations, messaging and core, domain-agnostic services needed to support tactical data flow.

202—Tactical domain services contain all of the domain-specific services that are required as a framework for higher level applications.

203—Tactical application services are the first active level of complete applications built on top of the tactical core and domain services. These applications utilize both the core and domain services to accomplish tactical tasking.

204—Enterprise messaging bus, such as JMS or DDS, that enables inter module as well as external module communication and data model management. Messaging bus can be swapped in/out with any compliant messaging system.

206—Persistence framework designed to abstract the database interactions away from the business processes. Standard frameworks such as Hibernate can be utilized to help further the abstraction.

207—Persistent data, housed within any database (sql, derby, oracle, etc).

208—Data models. Core, common data models for all modules and system types. All external entity and/or asset data is converted into these data models and passed around the system as such so that when an external interface changes, the data models only need to be updated in one place.

209—Core Command and Control framework designed to abstract the standard workflow for sending commands or signals to an external entity as well as receiving responses from those entities.

209-1—API that gets registered within the service registry for all services and applications within the system to utilize.

210—3rd party service repository for tactical core services that can be injected into any defined workflow process.

211—The heart of the infrastructure service framework. A dynamic service registry (such as OSGi) that maintains a registry of all existing services as well as dispatches service requests between services.

212-214—Example domain services that will run on within the application server container. Examples include Operations management, Payload Management and Logistics management as well as their corresponding API's that are registered within the service registry.

215—Tactical core services APis that are registered with the service registry as well as exposed via web-service based technologies for all services to access.

216—Tactical domain services APis that are registered with the service registry as well as exposed via web-service based technologies for all services to access.

217—Tactical application service APis that are registered with the service registry as well as exposed via web-service based technologies for all services to access.

218-220—Example tactical applications and services that will run on within the tactical applications layer. Examples include Tasking management and Collaboration management as well as their corresponding API's that are registered within the service registry.

221—External Entities—External entities that push, pull and receive data from the infrastructure framework. These entities are typical standard interfaces, such as LINK 16 as well as entities that are directly controlled via the infrastructure framework, such as an air vehicle asset.

222-224—External entities tapping into the data contents of the infrastructure for further processing or visualizations. Typical example would be a presentation layer visualizing the data contents.

225—Service registry communications. Standard, open communications to register, lookup and directly task services that are registered within the registry.

226—Data model/Data bus communications to subscribe or publish to the data model management services.

227—Inter-Package communication, using open, web-service based protocols as well as service registry protocols.

Sample Use Case(s):

Receive incoming data from 209 external entities:

1. Data received via a standard link (LINK 16).

2. Data is translated into the solution data model format 204.

3. Data is passed to the 204 enterprise messaging system to be dispatched the appropriate entity.

4. 206 Database services receive incoming 204 data, 206 persist as necessary and 226 alert the system of the new data changes.

5. 202-203 Subscribed enterprise applications receive data and process accordingly.

Presentation Framework

The application presentation framework is built off of multiple, widely used and supported open source presentation technologies: NASA WorldWind Java and Java FX. The presentation framework consists of a layer management component, services layer component, data model management and a plugin management framework.

Building on top of the open source Java world wind core capabilities, we have implemented a layer management framework to allow for highly customizable user interface. The help reduce clutter and give the user the ability to see only the data he needs, the layer management component allows the user to selectively show/hide any items they chose.

The presentation layer is completely decoupled from any single infrastructure. The presentation layer connects to external systems via open interfaces (services, JMS, DDS, etc) and populates its local data models accordingly. The services components use open contracts (WSDLs, JMS, XML) to communicate with an infrastructure that allows the presentation layer to quickly integrate into legacy infrastructures or used to augment current presentation systems. This allows the customers to not be tied to a single presentation layer and/or infrastructure, adding or removing presentation components as necessary.

Similar to the infrastructure, the presentation has a set of core data models that can either be shared with the core infrastructure or independently extended based on customer need. Since the presentation layer can be used without the infrastructure, the core data model concept as described in the infrastructure is applied to the presentation layer as well. The data model layer provides open interfaces to populate and augment the core data models with external data, leaving little to software development needed for integrating with external or third party data feeds.

102—Adapter layer designed to house external communications adapters that abstract away the details about the protocols and messaging formats from the rest of the presentation layer.

103—Module layer which is designed to configure the adapter layer communications and further filter and abstract the data messaging protocols and formats away from the rest of the presentation layer.

104—Proxy layer is a dispatch layer where proxies can be created to filter and distribute data more efficiently.

105—Plugin layer is the visualization layer where components can be added to any visualization service and communicate directly with the proxy layer (or any other layer) to receive its data.

106-108—Example adapters that can be created to communicate with

ANY external entity.

106-108-1—APIs for the adapters to register themselves with the service registry for all to see.

109—Core adapter API that all adapters must implement to properly be managed and discovered within the system.

110-115—Example Modules designed to configure the adapters and filter the data. These modules come standard with any tactical installation.

116—Container for extensible 3rd party modules to live along side of or replace existing modules.

117—Core module API that all modules must implement to properly be managed and discovered within the system.

118-123—Example proxies designed to abstract away the communications details from the presentation layer and filter the data. These proxies can come standard with any tactical installation.

124—Container for extensible 3rd party proxies to live along side of or replace existing proxies.

125—Core proxy API that all proxies must implement to properly be managed and discovered within the system.

126—Core plugins available for all tactical systems.

127—Container for extensible 3rd party plugins to live along side of or replace existing plugins.

128—Core plugin API that all plugins must implement to properly be managed and discovered within the system.

129—Service registry communications to register, look-up as well as task core registered services.

130—Service registry communications to register, look-up as well as task all services and applications within the system

131—The starting point for the application is a service registration component to allow all components of the application to communicate with each other.

132—The service manager and its api designed to manage and monitor the services and system communications as well as provide services for others to query and listen for service events.

133—Core visualization components.

134—Generic layout management services for all components to use.

135—Plugin manager controls loading and unloading of plugins.

136—Extensible container for 3rd party visualization services.

137—Core GIS Services provided for all components to use.

138—Core Widget services provided for all components to use.

140-141—Any External entity that communicates directly with the adapters via any communication protocol.

142-144—Open, extensible communications between any entity and the adapter layer.

Plugin Framework

The plugin framework is what enables the presentation layer to be truly extensible. Through this framework developers have the ability to add their own data visualizations to the application, by creating new layers to be placed on an visualization surface. The API provided is extremely open and allows for the introduction of any custom graphical element that may be displayed within the application. The API also allows developers to quickly establish connections to external data sources which the plugin can then act on. This enables the customer to develop capabilities on the fly as needed as well as allowing for the application to be quickly extended given customer requirements. Plugins are highly configurable and can be built to enable new 3D modeling capabilities or something as simple as a new status widget. The plugins can also be added/removed dynamically without having to recompile or redeploy the system.

The plugin paradigm is a perfect complement to a SOA system. Not only is the entire presentation layer replaceable, but the internals of the presentation are also interchangeable. This allows for new technologies to be integrated quickly into the displays without having to rewrite the core infrastructure.

Plugin Drawing:

1. The plugin which will be developed by the client. The only access to the Plugin Framework is via the provided API, which will allow clients to create custom graphics and connect to external services.

2. Allows clients to extend the WorldWind layer construct to add their own layers to the globe.

3. Allows clients to easily connect to external data sources via a JMS interface. All that must provided is the location of the JMS service and the framework will handle retrieving the data.

4. If the plugin has settings that should be able to be managed by the user, this module allows clients to specify them. The settings will be automatically displayed as JavaFX widgets on the main application menu.

5. If the plugin has any tools that must be made available to the user, this module will allow them to be created and displayed on the main application window as JavaFX widgets.

6. Provides an easy mechanism to display 3D data on the globe. Users need not write custom code to put 3D objects on the globe unless some custom mechanism is desired.

Communication Framework

The communication framework is designed to allow for quick integration with hardware components (radios, links, etc). The framework exposes all the hardware interfaces as SOA-compatible services to the rest of the infrastructure so that no internal clients need to be aware of the specific hardware implementation of a communication link, for example. Low level hardware drivers and interface changes are abstracted away so a change in communications hardware doesn't result in a ripple effect of changes in all parts of the infrastructure and even presentation layer.

The communications framework exposes open contracts to the rest of the system so that any SOA-compatible service or system can quickly integrate, control and communicate with the hardware. In a world where the hardware changes just as frequently as the software, the communications framework enables the customer to be flexible in their choice of hardware without having to worry about upgrading or replacing hardware components of the system.

Component Breakdown:

300—Communications Framework—Built as a SOA compatible set of modules, this framework can be added or removed from any SOA container.

301—Service Layer: The open, web-service based set of services designed to expose the hardware interface to the rest of the applications.

302—Data translation module. Translates hardware messages into SOA compatible messaging formats.

303—Device manager—Container for device specific drivers and proprietary protocols. New devices can be added/remove from this manager with no impact to the rest of the communications framework.

304—Device Modules—Self-contained modules that contain the specific details, messaging patterns and protocols for talking to specific hardware devices.

305—Protocol manager—Designed to abstract common protocols away from each of the devices and the infrastructure so there is a standard pool of protocol software for all devices to use. Example standards would include things like TCP/IP, 1553, ARINC 249, etc.

306—External Hardware device. Any localized hardware device that requires specific protocol and/or drive to communicate with the solution core.

307—Hardware specific I/O (TCP/IP, etc).

308—Open standard communication between the service layer and infrastructure framework.

Sample Use Case(s):

Communications with a 1553-based hardware device.

1. External device connects to the protocol manager, which designates a connection (port, etc) for the device to operate on.

2. Protocol manager decides the type of device and instantiates one or many device modules that contain the specific details on the messages for each of the devices.

3. Device manager utilizes the data translation services to convert the proprietary hardware-specific messages into the solution core data model formats.

4. Service layer transmits the solution core data models to the infrastructure framework for any further processing, if necessary.

Training Framework

The training framework is built into all components of the system. The training framework enables logging and playback abilities for all data feeds, scripted simulation mode as well as on the fly training all in one system.

By recording very fine details of how the system is being used, the operators can playback their missions, see where they could have done things differently or where things were done well.

The system is integrated with a number of simulation elements that allow the user to view and control assets or other systems just as if they were using the deployed system. The infrastructure doesn't make a distinction between the data feeds (simulated, real) so the transition between training and deployment is seamless.

Instructors can script scenarios in the framework and watch the play out on the system and monitor the user's interactions. They system can be paused and moved backwards or forwards in time, allowing a user to re-try or skip scenarios.

Component Breakdown:

400—Training framework—Built as a SOA compatible set of modules, this framework can be added or removed from any SOA container.

401—Temporal control module—Designed to expose and control time based responses, actions and data dissemination to the infrastructure framework.

402—Event Engine—Designed to produce and consume significant events that occur within the system to either store them for later playback or produce them during playback.

403—Looped communications between all engines, controlled via the temporal control module.

404—Service Layer—The open, web-service based set of services designed to expose the training interfaces to the rest of the applications.

405—Simulation Engine—Plug-able simulations that enable simulation and emulation of dynamic external interactions (e.g. air vehicle, satellite, etc).

406—Script Engine—Designed to allow for scripted play of system interactions.

407—Training persistence data—Persistence data required for playback and script execution. Persistence data can be configured to come from any set of databases, such as real-time flight logged data.

408—Open standard communication between the service layer and infrastructure framework.

Sample Use Case(s):

Replay of Mission:

1. Training framework is set to playback from a flight logged database.

2. Temporal control modules start the engine loops, setting for real time playback.

3. Script engine retrieves logged data, parses and feeds to the event engine for processing.

4. Event engine pushes the messages, via the service layer to the infrastructure for further processing.

5. event engine pushes the messages to the simulation engine

6. simulation engine determines if the messages require emulation or simulations of external entities, pushes messages to the service layer if necessary, otherwise it closes the loop back with the script engine to read the next set of temporal messages.

Situational Awareness

The Situational Awareness (SA) solution is designed to give the user a complete asynchronous, real-time, operational view. The SA solution contains several modular plugin to allow the user to view real-time status of any given asset that the system is connected to. From real-time asset monitoring and tracking to predictive modeling of asset future as well as reviewing of asset history.

The SA solution is capable of displaying and manipulating status data from multiple dissimilar assets in a single operational view. The system has the capability to show and maintain status in a 4 dimensional set of next generation user interfaces that is highly configurable and extensible. The SA solution provides tools and utilities to manipulate real time and offline data for real-time analysis using the latest in graphing and charting capabilities.

Based on the SOA infrastructure and plugin based presentation architecture, the SA solution is highly configurable and extensible. As new assets or sets of data are available to view, the SA solution will pick up on these data feeds and display the information for the user. In addition, the user can extend the SA solution by adding their own SA interfaces, 3D models, data sources, etc, with little to no development effort.

The SA solution is intended to bring together all of the dissimilar systems in one common operational picture.

Command & Control

Command and Control (C2) can take on many forms and traditionally requires every system to have their own specific command and control set of interfaces. The C2 solution is designed to break the paradigm of using multiple C2 systems for multiple assets. The C2 Solution is built on top of the SOA framework and in fact is seamlessly weaved into the infrastructure. The C2 solution provides a set of services that enable any and all systems to easily integrate their systems C2 messaging into the C2 solution.

The C2 solution meshes together common commands that are typically seen across multiple dissimilar systems as well as gives the user the ability to extend from these common command sets and integrate their specific command and control interfaces. This enables the community to essentially integrate any legacy and future systems into the C2 infrastructure.

Operationally, the C2 solution is meant to be the single command and control interface for all asset types. From airborne assets to unmanned sea assets, the C2 solution not only provides the capability to integrate with each specific systems proprietary command structure, but it also provides a visual interface that is capable of viewing and dispatching command sets via a common set of controls. Combining all of these capabilities not only provides a compact solution for any system, it also reduces maintenance and training costs.

Operations Management

The Operations Management (OM) solution is designed to allow for operational planning, re-planning and dynamic tasking of assets. OM is traditionally done with individual systems, using 2D charting and graphic capabilities. The OM solution is built on top of the solution SOA framework and contains a set of services and applications enable the user to perform all the necessary tasks for operations management.

The OM solution contains services to aide in operational route planning, analysis and report generation. The OM solution also allows the users to update the operational plans in real time, publishing the updated routing or tasking information directly to an asset or set of assets.

Using innovative 4D user interfaces, operationally the system can be deployed and configured to manage the missions or operations of multiple dissimilar assets. In addition, since the OM solution is built on top of the SOA framework, it has the capability to be extended and augmented with other key services.

The OM solution will provide a common interface and set of services for all system and asset types, dramatically reducing the systems needed to deploy any particular asset.

What is claimed is:

1. A method for providing a presentation layer with a customizable user interface, comprising:
registering a first presentation service with a dynamic service registry using a first plugin application programming interface (API); and
presenting a first visualization of first data from a first data model to a user using the first presentation service registered with the dynamic service registry.

2. A method as defined in claim 1, further comprising:
registering a second presentation service with the dynamic service registry using a second plugin application programming interface (API); and
presenting a second visualization of second data from a second data model to the user using the second presentation service registered with the dynamic service registry.

3. A method as defined in claim 2, further comprising:
removing the second infrastructure service from the dynamic service registry by removing the second plugin application programming interface (API).

4. A method as defined in claim 1, further comprising:
registering a first infrastructure service with the dynamic service registry using a third plugin application programming interface (API); and
populating the first data model with data from the first infrastructure service.

5. A method as defined in claim 4, further comprising:
registering a second infrastructure service with the dynamic service registry using a fourth plugin application programming interface (API); and
populating a second data model with data from the second infrastructure service.

6. A method as defined in claim 1, wherein:
the first data model includes second data; and
the user selectively hides the second data from the presentation of the first visualization.

7. An apparatus for providing a presentation layer with a customizable user interface, comprising:
a first registered presentation service that presents a first visualization of first data from a first data model to a user; and
a dynamic service registry that registers the first registered presentation service using a first plugin application programming interface (API).

8. An apparatus as defined in claim 7, further comprising:
a second registered presentation service that presents a second visualization of second data from a second data model to a user; and
a dynamic service registry that registers the second registered presentation service using a second plugin application programming interface (API).

9. An apparatus for providing a presentation layer with a customizable user interface, comprising:
first means for presenting a first visualization of first data from a first data model to a user; and
second means for registering the first means using a first plugin application programming interface (API).

10. A computer program product, comprising:
computer-readable storage medium,
comprising:
code for causing a computer to register a first presentation service with a dynamic service registry using a first plugin application programming interface (API); and
code for causing a computer to cause a present a first visualization of first data from a first data model to a user using the first presentation service registered with the dynamic service registry.

11. A computer program product as defined in claim 10, further comprising:
code for causing a computer to register a second presentation service with the dynamic service registry using a second plugin application programming interface (API); and
code for causing a computer to present a second visualization of second data from a second data model to the user using the second presentation service registered with the dynamic service registry.

12. A computer program product as defined in claim 11, further comprising:
code for causing a computer to remove the second infrastructure service from the dynamic service registry by removing the second plugin application programming interface (API).

13. A computer program product as defined in claim 10, further comprising:
code for causing a computer to register a first infrastructure service with the dynamic service registry using a third plugin application programming interface (API); and
code for causing a computer to populate the first data model with data from the first infrastructure service.

14. A computer program product as defined in claim 13, further comprising:
code for causing a computer to register a second infrastructure service with the dynamic service registry using a fourth plugin application programming interface (API); and
code for causing a computer to populate a second data model with data from the second infrastructure service.
